(19) United States
(12) Patent Application Publication
(10) Pub. No.: US 2021/0154831 A1
(43) Pub. Date: May 27, 2021

(54) INFORMATION PROCESSING METHOD, ROBOT SYSTEM, ARTICLE MANUFACTURING METHOD AND INFORMATION PROCESSING APPARATUS

(71) Applicant: CANON KABUSHIKI KAISHA, Tokyo (JP)

(72) Inventor: Gen Kimura, Kanagawa (JP)

(21) Appl. No.: 17/091,894

(22) Filed: Nov. 6, 2020

(30) Foreign Application Priority Data
Nov. 22, 2019 (JP) 2019-211778

(51) Int. Cl. B25J 9/16

(52) U.S. Cl. CPC B25J 9/1605; B25J 9/1664

(57) ABSTRACT

An information processing method, includes an acquisition step in which a control device acquires a starting point and an ending point of a motion of a first object model in a virtual space, a trial step in which the control device tries to generate a branch composing a tree structure model, an interference determination step in which the control device determines whether the branch generated in the trial step interferes with a second object model in the virtual space, and a first branch adding step in which the control device moves the first object model in the virtual space based on kinematics conditions related to the first and second object models in a case where an occurrence of the interference has determined in the interference determination step and adds a moving path of the first object model to the tree structure model as a branch in the interference determination step.

### BACKGROUND OF THE INVENTION

### Field of the Invention

The present invention relates to an information processing method, a robot system, a manufacturing method of articles and an information processing apparatus.

### Description of the Related Art

Computer Aided Design (CAD) technology is being widely utilized in designing and assembling industrial products and their parts. The CAD enables to select various output forms such as 3D display and animation display. In a simulation process utilizing the CAD technology of this sort, there is a case where an environment of handling models of objects such as the industrial product and its part or a robot device handling them is called as a virtual environment. Then, by moving the object models simulating the industrial product and its part or the robot device handling them in the virtual environment, it is possible to evaluate designs of the object models and their operation mode.

Parts to be assembled in a manufacturing process need to be designed into such shapes that can be assembled. However, there is a case where it is difficult to confirm whether the parts can be assembled only by a display of an output screen in the prior art CAD technology.

In such a case, it is necessary to prepare a trial product and to try actual assembly to evaluate its design. If it is unable to assembly the trial product, it is necessary to feed back its information to a design step to redesign the part by using the CAD. Thus, there are such problems that a design time is prolonged and it is costly to prepare the trial product.

Then, there is a possibility that the cost of the trial product can be cut and to shorten the design time if it is possible to steadily judge whether the part can be assembled by generating assembling trajectory of the part in the virtual space for example. However, it is often more difficult in the prior art to generate the trajectory, e.g., the assembling trajectory where the parts come close with each other, because areas of apertures where the parts can take are narrow.

Industrial robots are being put into production lines of automobiles and electric products to automate such works as welding and assembly. In such production site, robot devices, workpieces, work tables, tools and other peripheral units are disposed in a state where they may come into contact with each other.

### SUMMARY OF THE INVENTION

According to a first aspect of the present invention, an information processing method, includes an acquisition step in which a control device acquires a starting point and an ending point of a motion of a first object model in a virtual space, a trial step in which the control device tries to generate a branch composing a tree structure model which sets at least either one of the starting point or the ending point as a start point in the virtual space, an interference determination step in which the control device determines whether the branch which has been generated in trial in the trial step interferes with a second object model in the virtual space, and a first branch adding step in which the control device moves the first object model in the virtual space based on kinematics conditions related to the first and second object models in a case where an occurrence of the interference has determined in the interference determination step and adds a moving path of the first object model to the tree structure model as a branch in the interference determination step.

According to a second aspect of the present invention, an information processing apparatus includes a control device configured to execute an acquisition step of acquiring a starting point and an ending point of a motion of a first object model in a virtual space, a trial step in which the control device tries to generate a branch composing a tree structure model which sets at least either one of the starting point or the ending point as a start point in the virtual space, an interference determination step of determining whether the branch which has been generated in trial in the trial step interferes with a second object model in the virtual space, and a first branch adding step of moving the first object model in the virtual space based on kinematics conditions related to the first and second object models in a case where an occurrence of the interference has determined in the interference determination step and of adding a moving path of the first object model to the tree structure model as a branch in the interference determination step.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a trajectory generating system according to a first exemplary embodiment of the present disclosure.

FIG. 2 is a diagram illustrating set conditions in generating a trajectory according to the first exemplary embodiment of the present disclosure.

FIG. 3 is a diagram illustrating a process in generating a path according to the first exemplary embodiment of the present disclosure.

FIG. 4 is a diagram illustrating a process in generating a further path according to the first exemplary embodiment of the present disclosure.

FIG. 5 is a diagram illustrating a different process in generating a further path according to the first exemplary embodiment of the present disclosure.

FIG. 6 is a diagram illustrating a still different process in generating a further path according to the first exemplary embodiment of the present disclosure.

FIG. 7 is a diagram illustrating a process in generating a further path according to the first exemplary embodiment of the present disclosure.

FIG. 8 is a diagram illustrating a process in generating a path according to the first exemplary embodiment of the present disclosure.

FIG. 9 is a diagram illustrating a process in generating a path according to the first exemplary embodiment of the present disclosure.

FIG. 10 is a block diagram illustrating a hardware structure according to the first exemplary embodiment of the present disclosure.

FIG. 11 is a flowchart illustrating the processes in generating the paths according to the first exemplary embodiment of the present disclosure.

FIG. 12 is a diagram illustrating different set conditions in generating a trajectory according to a second exemplary embodiment of the present disclosure.

FIG. 13 is a diagram illustrating different set conditions in generating a trajectory according to the second exemplary embodiment of the present disclosure.

FIG. 14 is a diagram illustrating different set conditions in generating a trajectory according to the second exemplary embodiment of the present disclosure.

FIG. 15 is a diagram illustrating a process in generating a path according to the second exemplary embodiment of the present disclosure.

FIG. 16 is a diagram illustrating a state in searching a path by a prior art RRT.

### DESCRIPTION OF THE EMBODIMENTS

Modes for carrying out of the present disclosure will be described below with reference to the attached drawings. Note that configurations described below are examples to the end, and a person skilled in the art would be able to appropriately modify their detailed configurations for example within a scope not departing from a gist of the present disclosure. Still further, numerical values adopted in the present exemplary embodiment are merely illustrations of reference numerical values.

### First Embodiment

An opportunity of utilizing simulation in creating a robot motion trajectory in a production line has increased lately, and a technology of automatically generating such trajectory by which a robot device does not interfere with peripheral devices is being developed. However, it is very difficult to create such trajectory by which the robot avoids from interfering with the peripheral devices in works such as a workpiece assembling work in which a distance between objects is close because a range of an attitude which the robot can take is narrowed.

Hitherto, there has been known an information processing method for searching a path along which a robot device and an object to be operated and moved by the robot device are moved while avoiding from interfering with an obstacle. As such information processing method, there has been known RRT (Rapidly-exploring Random Trees) for example.

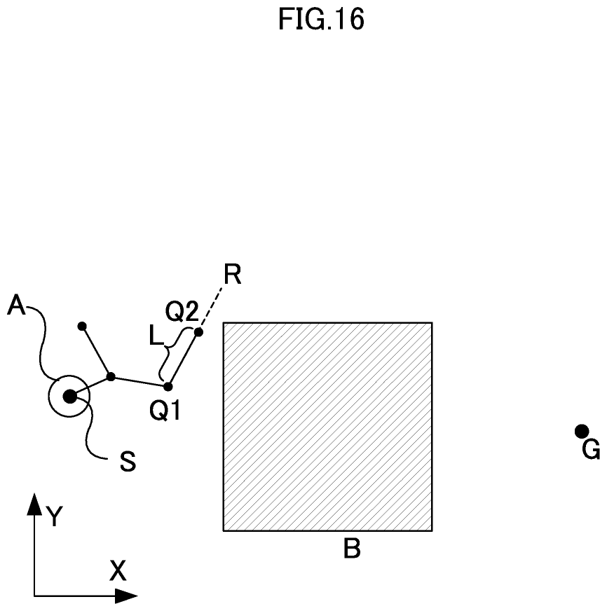

FIG. 16 illustrates a state of the path search in a virtual space by the RRT. Here, the virtual space in which an object model is moved is considered to be a two-dimensional plane to simplify the description. In FIG. 16, an object model A is a circular rigid body operated on X and Y planes and an object model B is a quadrangle static rigid body, respectively. In this example, a path of the object model A reaching from a start point S to a target point G while avoiding interference such as contact and collision with the object model B is sought.

In calculation of the RRT, a process of placing a point R at random within a movable range of the object model A on the X and Y planes is tried at first and a point Q1 on a tree structure closest to the point R is calculated.

Next, a point which is extended from the point Q1 toward the point R by a maximum length L is set as a point Q2. Then, if the object model A does not interfere with the object model B on a line segment Q1-Q2, position information of the point Q2 and the point Q1, i.e., a parent of the point Q2, is stored as a branch of the tree structure. It is possible to generate the path to the target point G by repeating the processes of growing the tree structure model from the point R generated at random as described above.

The RRT technology aims at searching a path of an object to be operated for reaching to a target point while avoiding interference with an obstacle. Then, there is a possibility that the tree structure does not grow and no progress is made in the path search in a narrow environment in which a distance between an object to be moved and the obstacle is short and in which the object has to be sneaked through a thin moving path. For instance, it is difficult for the prior art RRT to make such robot operation of fitting a pin having a small clearance into a hole or to generate such assembly trajectory that the robot performs such operation at an assembly position located ahead of a narrow space.

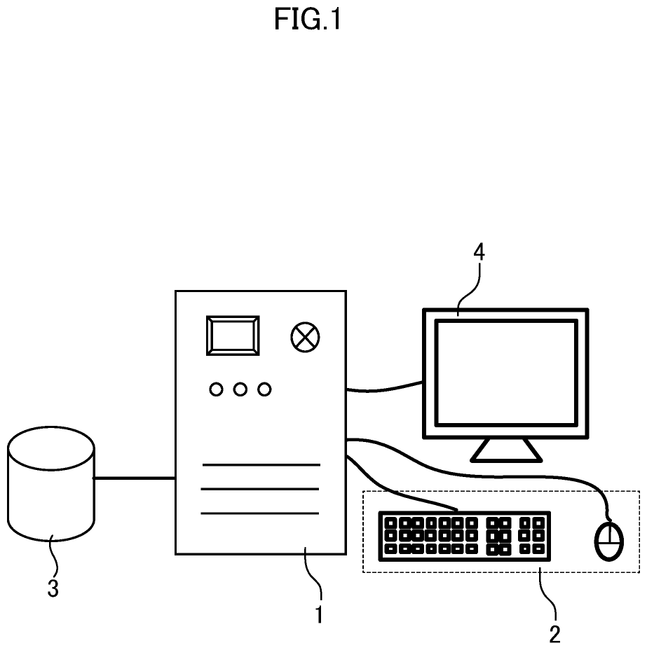

FIG. 1 illustrates a schematic structure of a path generating apparatus serving as a trajectory generating apparatus and as an information processing apparatus of the present exemplary embodiment. This path generating apparatus includes a control device 1, an input portion 2 through which a teacher input data and the like, a recording portion 3 configured to record an operation program and the like and a display portion 4 used in displaying motion trajectories of a part and a robot. The control device 1 is a control device having a so-called PC (personal computer) form for example in which peripheral devices such as ROM and RAM are disposed centering on a control unit such as CPU. The recording portion 3 is an external storage device such as HDD and SSD and the display portion 4 is composed of an LCD display and the like.

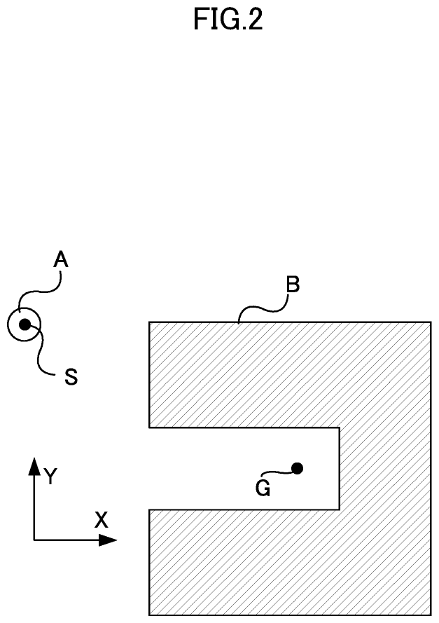

FIG. 2 illustrates condition setting in generating a trajectory of the present exemplary embodiment. Here, a path through which the object model A serving as a first object model moves from a start point S to reach to a target point G while avoiding interference with a stationary object model B serving as a second object model is sought in a virtual two-dimensional space to simplify the description. The object model B has a U-shaped cross-section, and the target point G of the move of the object model A is disposed at a rear part of the recess. The both of the object models A and B correspond to specific rigid models in the actual world.

The object model A may be considered to be what simulates a part or the like of an industrial product having a degree of freedom of translation and/or rotation by being operated by a robot device for example. The object model B may be considered to be an obstacle disposed within a work space of the robot device or a receiving-side part that fits with a part corresponding to the object model A. The target point G corresponds to an assembling position of the part corresponding to the object model A for example.

Note that the object model A may be what is widely recognized as a moving body in general and is not required to be construed in a specifically limited manner. Still further, the object model A which is the object whose trajectory is to be generated may be associated not only with the object to be operated by the robot device but also with a reference part of the robot, e.g., a tool or a center of the tool. In this case, a driving method or the like of the robot device is arbitrary, and its joint configuration may be any configuration including a 6-axis articulated form or a direct-acting type form.

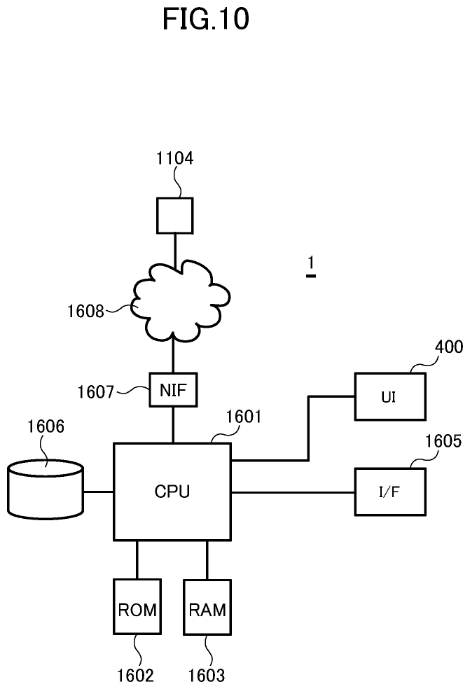

Here, FIG. 10 illustrates one example of a specific hardware structure of the control system composing the control device 1 in FIG. 1. The control system as illustrated in FIG. 10 can be realized by a packaging form of a so-called PC form for example.

The control system as illustrated in FIG. 10 can be composed of PC hardware including a CPU 1601 serving as a main control portion and a ROM 1602 and a RAM 1603 serving as storage units. Control programs, constant information and others of the CPU 1601 for realizing processing procedures in generating the path of the present exemplary embodiment can be stored in the point ROM 1602. The RAM 1603 is used also as a work area of the CPU 1601 when the control procedure is executed. Still further, the control system in FIG. 10 is connected with an external storage unit 1606. The external storage unit 1606 is not always necessary for carrying out the present disclosure and may be composed of an external storage unit of another system mounted through network such as HDD and SSD.

The control program of the CPU 1601 for realizing the path generating process of the present exemplary embodiment is stored in the storage unit such as the external storage unit 1606 and the point ROM 1602, e.g., its EEPROM area, described above. In such a case, the control program of the CPU 1601 for realizing the control procedure of the present exemplary embodiment can be supplied to each storage unit described above or can be updated to a new different program through a network interface 1607. Or, the control program of the CPU 1601 for realizing the control procedure described later can be supplied to each storage unit described above and can update its contents through a storage units such as various magnetic disks, optical disks and a flash memory and through a drive unit to that end. The various storage units, storage portion or storage device in a condition of storing the control program of the CPU 1601 for realizing the control procedure of the present exemplary embodiment composes a computer-readable storage medium storing the control procedure of the present disclosure.

The network interface 1607 can be constructed by using such communication standards for cable communication of IEEE 802.3 and for radio communication of IEEE 802.11 and 802.15 for example. The CPU 1601 can communicate with another unit 1104 through the network interface 1607 and a network 1608. As the other unit 1104, it is possible to connect a general control device or a server unit of the robot system composing the production line.

The control device of FIG. 10 also comprises a user interface unit 400, i.e., an UI unit. A GUI (Graphical User Interface) composed of a LCD display, a keyboard, a pointing device such as a mouse and a joy stick may be disposed as the user interface unit 400. Such GUI may be composed of the input portion 2 and the display portion 4 in FIG. 1 for example. It is possible to inform a user of the progress of path generating processing through the user interface unit 400 composed of such GUI for example For instance, it is possible to inform the user of progresses of changes of the tree structure model described later through animation or the like outputted and displayed every second through the user interface unit 400. It is also possible to set various parameters controlling the path generating process through the user interface unit 400. For instance, it is possible to arrange such that the control device acquires user operation of setting the starting point, i.e., the start point, and the ending point, i.e., the target point, of the move of the object model A described later through the user interface unit 400.

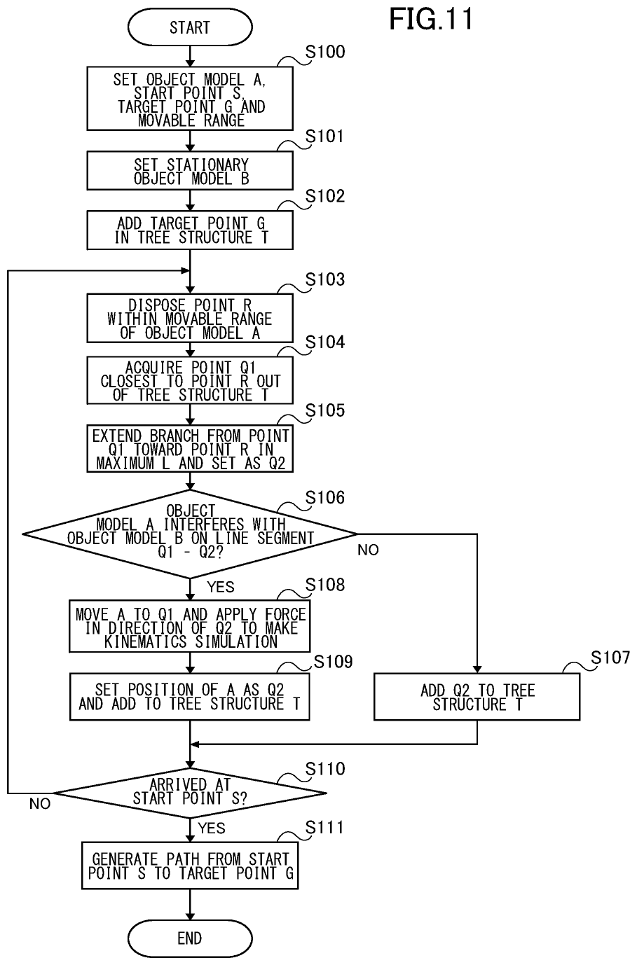

FIG. 11 is a flowchart illustrating control procedures of a trajectory generating process, i.e., the path generating process, of the present exemplary embodiment. In Step S100, i.e., in a setting step/acquisition step, in FIG. 11, the control device acquires the object model A which is an object to be operated, a start point S, i.e., the starting point and a target point G, i.e., the ending point, and sets a movable range. This setting is made by reading from another control terminal through network or is made in response to the setting operation of the user made through the user interface unit 400 composed of the input portion 2 and the display portion 4.

In Step S101, the control device sets the stationary object model B as an obstacle of the object model A. The control device makes this setting also in the similar manner with Step S100.

In Step S102, the control device adds the target point G corresponding to the ending point to which the object model A is moved in the tree structure T as a root. This tree structure is considered to be an aggregate of points connected by branches, and a point on the tree structure is considered to have information of a parent point and path information, i.e., branch information, from the parent point, except of the root. The control device clears the parent and path information of the point into an empty state. Such tree structure T may be stored on the memory in a form of linked list for example.

Note that why the target point G which corresponds to the ending point to which the object model A is moved as the root is because the search becomes easier to grow the tree structure from the target point because the object model B comes close to the object model A around the target point in the example in FIG. 2 in the present exemplary embodiment. However, the root of the tree structure may be placed not only at the target point but also at the start point. It is also possible to adopt a method of growing two tree structures by setting both of the starting point and the target point as roots. It is possible to arrange such the user can set the starting point and the target point through the user interface composed of the input portion 2 and the display portion 4.

Next, the control device tries to generate branches composing the tree structure model in a branch generation trial step in Steps S103 through S105. The control device determines whether interference of the object model A with the object model B has occurred on the branches generated in trial in an interference determination step in Step S106. Then, in response to a result of Step S106, the control device executes a different branch adding process, i.e., a first branch adding step or a second branch adding step in Step S109 or S107.

If no interference has occurred in the abovementioned interference determination, the control device adds the branches generated in trial in Steps S103 through S105 to the tree structure model, i.e., the second branch adding step in Step S107. In a case where the interference has occurred, the control device executes a kinematics simulation in Step S108 and moves the object model A from a starting point of the branch generated in trial. Then, the control device adds a moving path acquired by the kinematics simulation to the tree structure model as a branch in the first branch adding step in Step S109.

Then, the control device repeatedly executes the abovementioned steps and in a case where the start point, i.e., the starting point, is connected with the target point, i.e., the ending point, through the tree structure model, the control device generates a branch connecting from the starting point to the ending point on the tree structure model as a path along which the object model A is to be moved in a path generating step in Step S111.

In Step S103, the control device generates a point R at random or in a certain direction within the movable range of the object model A at first. In this case, it is conceivable that the point R is generated at the start point or at a same position thereof once in several times in Step S103 in the loop. Thereby, there is a possibility that a time required for the search is shortened.

In Step S104, the control device acquires a point Q1, i.e., a second point, closest to the point R among the tree structure T. In a case where there is only the target point G, i.e., the root, in the tree structure T, the control device sets the target point G as Q1.

In Step S105, the control device extends the branch by the maximum length L in a direction from Q1 to the point R and sets a position thereof as the point Q2, i.e., a first point. In a case where a line segment Q1-R is larger than the length L, the control device sets Q2 such that a length of a line segment Q1-Q2 becomes L on the line segment Q1-R. Meanwhile, in a case where the line segment Q1-R is smaller than the length L, the control device sets a position of the point R as Q2.

In Step S106, the control device determines whether the object model A interferes with the object model B on the line segment Q1-Q2. In a case where they do not interfere with each other, the process is shifted to Step S107 and in a case where they interfere with each other, the process is shifted to Step S108.

In Step S107, the control device sets the parent as the point Q1 and adds the line segment Q1-Q2 to the tree structure T as a path from the point Q1 to the point Q2.

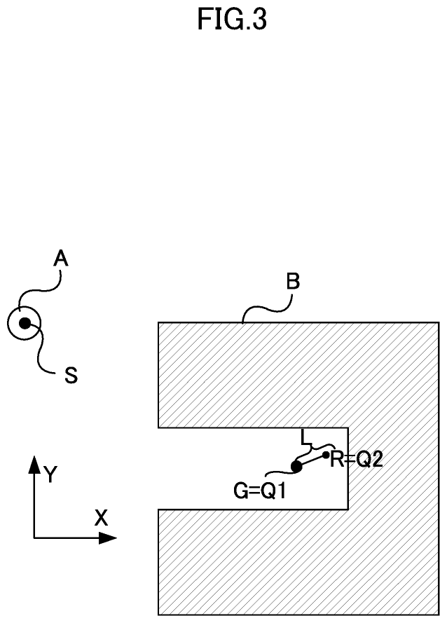

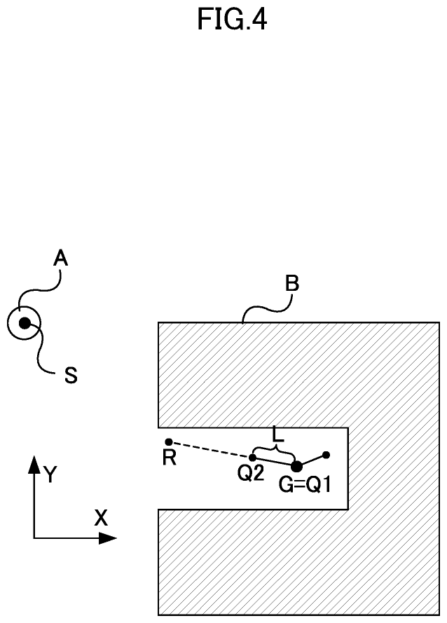

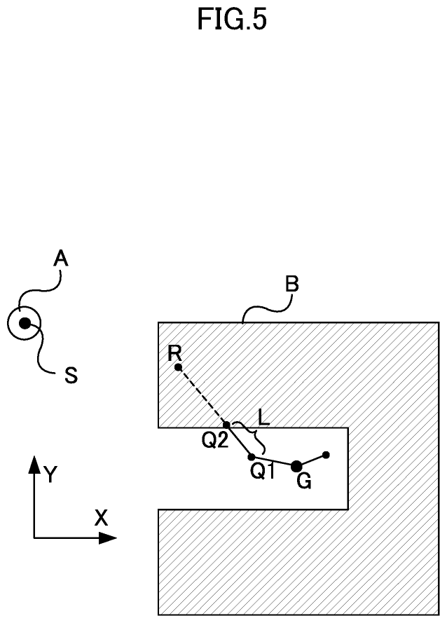

Here, FIG. 3 illustrates a case where the point R is disposed in a case where the tree structure is composed of only the target point G. Because the line segment Q1-R is less than the L, the point R is set as the point Q2 as it is. FIG. 4 illustrates a case where the point R is disposed further on the tree structure in FIG. 3. In this case, because the line segment Q1-R is larger than the L, the point Q2 is set on the line segment Q1-R such that the length of the line segment Q1-Q2 is equalized with the L. FIG. 5 illustrates a state in which the point R is disposed in trial on the tree structure in FIG. 4 to extend the branch further. In this case, because the line segment crosses with the object model B on the line segment Q1-Q2, i.e., the object model A interferes with the object model B, the process is shifted from Step S106 to Step S108. In a case where the object model A interferes with the object model B on the line segment Q1-Q2 in Step S106, a force is applied in a direction of the point Q2 upon moving the object model A to the point Q1 by the known kinetics simulator process in Step S108 to execute a simulation for a certain time.

The kinetics simulator mentioned here is a simulator configured to calculate a motion of an object from an equation of motion by taking an external force and a contact force caused by collision of objects into account. The kinetics simulator renders shapes of object models by polygons, detects a collision by making contact determination calculation of the polygons and calculates the contact force by using velocities, masses, inertia, coefficients of rebound and others of the object models. Then, a motion path of the object model A acquired as a result of the kinematics simulation is stored in the tree structure in Step S109. Note that the application of the force to move the object model A does not specifically limit the present disclosure, and it is possible to adopt a method of executing a simulation for a certain time by applying initial velocity to the object model A from the position of the point Q1 in the direction of the point Q2 in Step S108 for example.

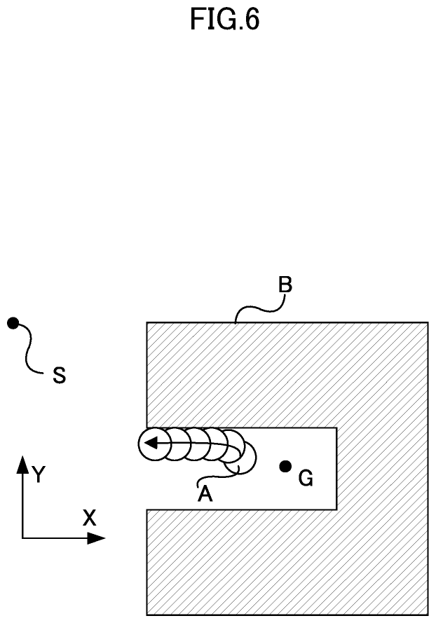

FIG. 6 illustrates an example of a trajectory continuously grown from the point Q1 in FIG. 5 by using vector of force or velocity to the object model A heading in the direction of the point Q2 by the kinematics simulation described above. Here, the vectors of the velocity or the force heading from the position of the point Q1 to the point Q2 can be decomposed to a component vertical to a wall of the object model B and a component horizontal to the wall. According to the kinematics simulation in FIG. 6, such a trajectory of the object model A that advances to a left side in FIG. 6 while keeping a contact with the object model B is acquired by the vertical and horizontal components to the wall of the object model B of the vectors of the same velocity or the force. Note that the control device repeatedly executes Step S108 in FIG. 11 during when the object model A contacts or interferes with the object model B, and the kinematics simulation is executed every time per certain time.

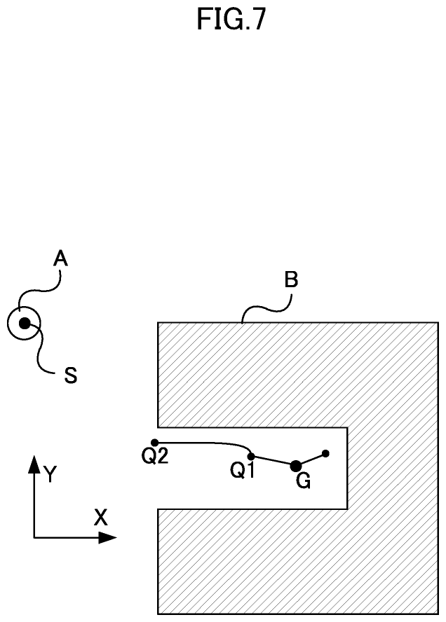

In Step S109, the control device replaces the position of the point Q2 with the position of the object model A after the kinematics simulation and adds the point Q2 into the tree structure T upon associating the path acquired by the kinematics simulation with the parent point Q1. FIG. 7 illustrates an example in which the branch is added to the tree structure based on the trajectory of the object model A as illustrated in FIG. 6.

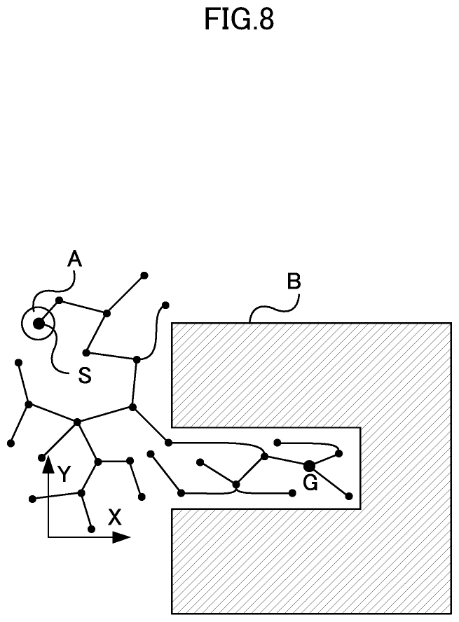

In Step S110, the control device determines whether the point on the tree structure is fully close to the start point S and if the point is close, determines that the tree structure has arrived at the start point S and shifts the process to Step S111. Otherwise, the control device returns to Step S103 to repeat the abovementioned operations. FIG. 8 illustrates one example of a state in which the tree structure has arrived at the start point as a result of repeating the operations of Steps S103 through S110.

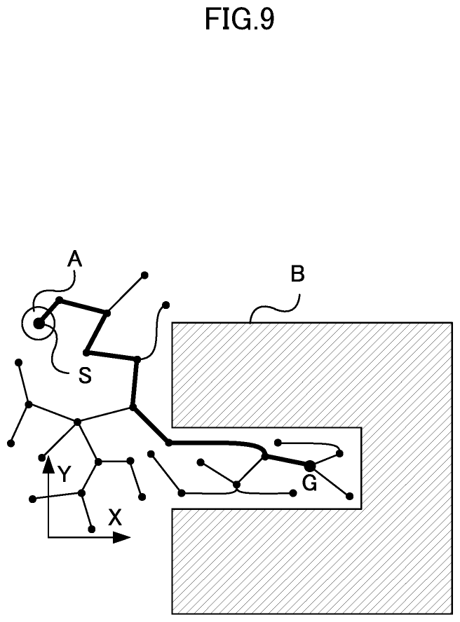

In Step S111, the control device synthesizes the paths stored in the respective points in the tree structure by following the paths to the parents from the point of the tree structure arriving at the starting point and outputs the path from the starting point to the target point. FIG. 9 indicates the path from the starting point to the target point acquired in Step S111 by a thick line.

As described above, according to the present exemplary embodiment, it is possible to generate the path that steadily avoids interference even in an environment in which a distance between an object model to be operated and a stationary object model becomes very close around a target point. Still further, because the known kinetics simulator can be used in the control procedure for generating the path, a maintenance cost in developing a system can be reduced. Still further, if the abovementioned object model A is replaced with a mobile type robot that moves in its work space, it is possible to generate a path reaching from a starting point to a target point of the robot while avoiding interference with a surrounding obstacle in an area where a distance to the surrounding obstacle is very close.

Or, the object model A may be associated with a first part of an industrial product and the stationary object model B may be associated with a second part or an obstacle having a shape which surrounds an assembling position of the object model A for example Then, it is possible to determine that the first part corresponding to the object model A can be assembled in a case where a path reaching from a starting point to a target point is generated by the control procedure described above for example. This makes it possible to evaluate adequacy of design of the first part for example Thus, it becomes unnecessary to make the part corresponding to the object model A described above in trial, which has been necessary in the past, and to reduce a trial cost of the part by utilizing the control procedure of the present exemplary embodiment in evaluating the design of the part of the industrial product.

### Second Embodiment

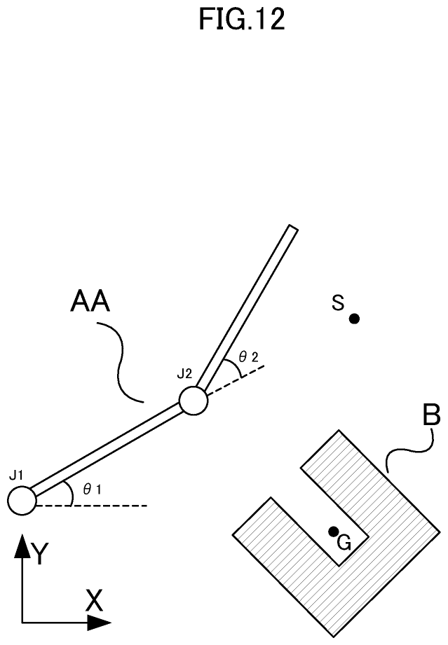

A second exemplary embodiment illustrates an example of generating a path for moving a reference portion corresponding to fingers of an articulated robot having two rotational joints for example from a starting point to a target point. FIG, 12 illustrates task conditions in generating a path of the present exemplary embodiment. In FIG. 12, a frame of a robot device AA is the articulated robot having links connected by two rotational joints J1 and J2. In FIG. 12, a joint angle of a first axis, i.e., J1, of the robot device AA is θ1 and a joint angle of a second axis, i.e., J2, is θ2, and an attitude of the robot device AA is determined uniquely if the points (θ1, θ2) on a two dimensional space are determined. Note that although the simple two joints robot is illustrated here to simplify the description, the following control can be made in the same manner if the robot device AA is a type such as a 6-axis articulated robot for example.

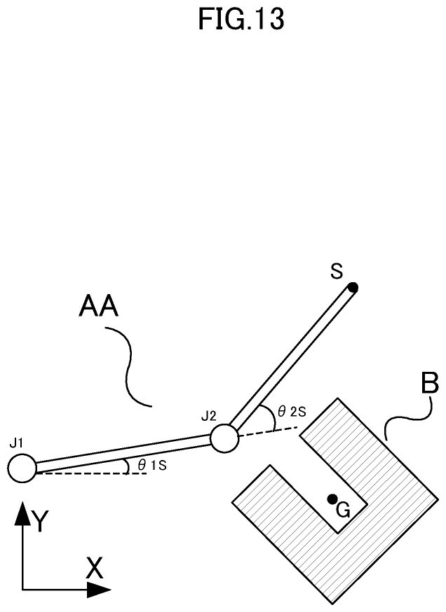

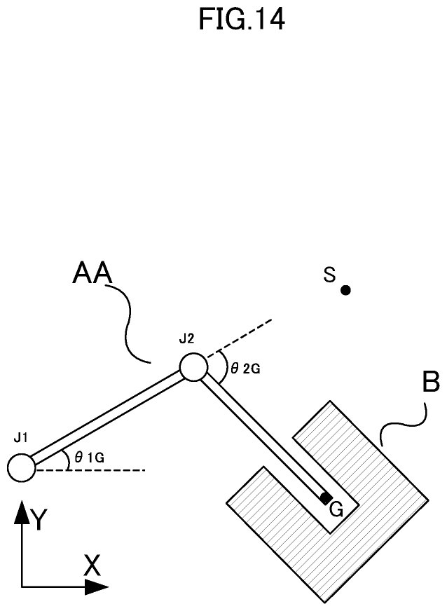

In the present exemplary embodiment, an attitude of the robot device AA when a distal end thereof is located at a position of the start point S is denoted as (θ1S, θ2S) and an attitude of the robot device AA when the distal end thereof is located at a position of the target point G is denoted as (θ1G, θ2G). FIGS. 13 and 14 illustrate the attitudes of the robot device AA at the start point S and at the target point G, respectively.

Path generation can be executed by the control procedure as illustrated in FIG. 11 also in the present exemplary embodiment. However, it is necessary to switch and to read the path generating process of the object model A of the first embodiment to a path generating process of the robot device AA in the present exemplary embodiment.

At first, the control device sets a model of the robot device AA naturally instead of the object model A in Step S100. Still further, the control device sets the points in the joint space (θ1S, θ2S) and (θ1G, θ2G) as the start point S and the target point G in Step S100, respectively, and sets all points R, Q1 and Q2 in Steps S103 through S105 on points on the joint space.

The control device also makes semi-kinematics calculation with an attitude denoted by points on a line segment Q1-Q2 to determine whether the robot device AA interferes with the object model B in Step S106. The control device also sets the robot device AA at an attitude denoted by the point Q1 on the kinetics simulator to apply a joint torque in a direction of the point Q2 or a joint angular velocity in the direction of the point Q2 as an initial velocity in Step S108.

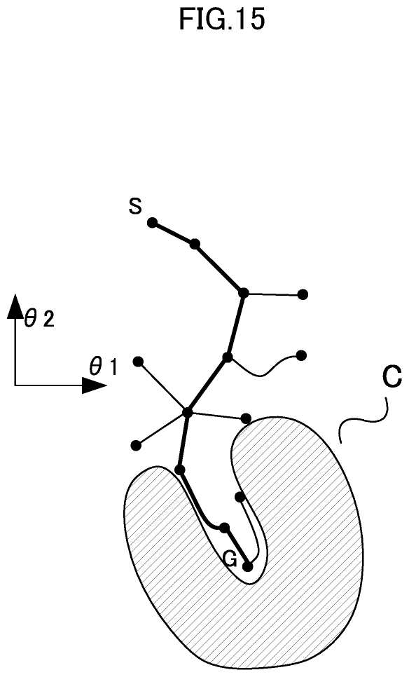

FIG. 15 illustrates a tree structure generated in the joint space and the path connecting the starting point with the target point acquired by executing the abovementioned processes. The path connecting the starting point with the target point is indicated by a thick line. C corresponds what the stationary object model B is transferred to the joint space of the robot device AA. Then, similarly to the first exemplary embodiment described above, the path for operating the robot device AA can be generated as indicated by the thick line in FIG. 15 from the tree structure generated in FIG. 15. Note that although an example of placing the points in the joint space to calculate the path has been described above, it is also possible to calculate not on the joint space but also on positions in a virtual space of reference portion set at fingers or the like of the robot device.

As described above, according to the present exemplary embodiment, it is possible to generate the path for operating the robot device precisely and quickly in a work in which the robot device AA composed of the articulated robot or the like manufactures articles from workpieces to be operated. Then, the generated path is transferred to the robot control device controlling the robot device AA as robot control data of a teaching point form for example. The robot control device may be disposed as the other unit 1104 in the configuration in FIG. 10 for example, and the robot control data may be transmitted through the network 1608. Thus, the robot device can be moved through the robot control device based on the generated path to manufacture the articles from the workpieces.

While the exemplary embodiments of the present disclosure have been described in detail, they are just illustrations and do not limit a scope of the claims. For instance, although the two dimensional plane has been mainly considered as the virtual space and the control examples of moving the object model therein have been illustrated, it is easy to amplify such control to acquire a control method of object models in a three dimensional space. Then, the technology described in the scope of claims includes what the exemplary embodiments illustrated above are variously deformed or modified.

The present disclosure can be realized also by processes of supplying a program realizing one or more functions of the exemplary embodiments described above to a system or a device through network or a storage medium and of reading and executing the program by one or more processors in a computer of the system or the device. It is also possible to realize it by a circuit, e.g., ASIC, of realizing one or more functions. The various exemplary embodiments described above are also applicable not only to the robot device but also to various machines configured to automatically perform expansion and contraction motions, bending and stretching motions, vertical and horizontal motions or spinning motions, or their composite operation, based on information of the storage unit of the control device.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-211778, Nov. 22, 2019, which is hereby incorporated by reference herein in its entirety.

What is claimed is:

1. An information processing method, comprising:
an acquisition step in which a control device acquires a starting point and an ending point of a motion of a first object model in a virtual space;
a trial step in which the control device tries to generate a branch composing a tree structure model which sets at least either one of the starting point or the ending point as a start point in the virtual space;
an interference determination step in which the control device determines whether the branch which has been generated in trial in the trial step interferes with a second object model in the virtual space; and
a first branch adding step in which the control device moves the first object model in the virtual space based on kinematics conditions related to the first and second object models in a case where an occurrence of the interference has determined in the interference determination step and adds a moving path of the first object model to the tree structure model as a branch in the interference determination step.

2. The information processing method according to claim 1, wherein the control device moves the first object model from the start point of the branch generated in trial in the virtual space based on the kinematics conditions in the first branch adding step.

3. The information processing method according to claim 1, further comprising a second branch adding step in which the control device adds the branch generated in trial to the tree structure model in a case where no interference has determined in the interference determination step.

4. The information processing method according to claim 3, wherein the control device repeatedly executes the trial step, the interference determination step, and the first branch adding step or the second branch adding step and in a case where the starting point is connected with the ending point through the tree structure model, executes a path generating step in which the control device generates a branch connecting from the starting point to the ending point on the tree structure model as a path along which the first object model is to be moved.

5. The information processing method according to claim 1, wherein the branch generated by the control device in trial in the trial step is a branch connecting a first point generated in the virtual space with a second point closest to the first point in the tree structure model.

6. The information processing method according to claim 1, wherein the control device determines that the interference has occurred in a case where a branch connecting a first point generated in the virtual space with a second point closest to the first point in the tree structure model interferes with the second object model.

7. The information processing method according to claim 5, wherein the first point is generated on a line connecting a point generated at a random position in the virtual space with the second point.

8. The information processing method according to claim 1, wherein the kinematics conditions include conditions of velocity or force in a case where the first object model comes into contact with the second object model in the first branch adding step, and
wherein the control device moves the first object model from the starting point of the branch generated in trial by using the condition of velocity or force and adds the moving path in the tree structure model as a branch in the first branch adding step.

9. The information processing method according to claim 5, wherein the control device uses a position of the starting point or the ending point of the motion of the first object model as a position of the first point to be generated in the trial step repeatedly executed.

10. A computer-readable non-temporal storage medium configured to store a control program executing each step of the information processing method according to claim 1.

11. A control method of a robot device in which the first object model in the information processing method according to claim 1 corresponds to a body of the robot device or an object to be operated by the robot device and by which operations of the robot device operating the object along a path generated are controlled.

12. A robot system comprising a robot device and a robot control device configured to control operations of the robot device along the path generated by the control method according to claim 11.

13. An article manufacturing method by which the robot device controlled by the control method according to claim 11 manufactures articles from workpieces by operating the workpieces as the object to be operated.

14. An information processing apparatus comprising a control device configured to execute:
an acquisition step of acquiring a starting point and an ending point of a motion of a first object model in a virtual space;
a trial step in which the control device tries to generate a branch composing a tree structure model which sets at least either one of the starting point or the ending point as a start point in the virtual space;
an interference determination step of determining whether the branch which has been generated in trial in the trial step interferes with a second object model in the virtual space; and
a first branch adding step of moving the first object model in the virtual space based on kinematics conditions related to the first and second object models in a case where an occurrence of the interference has determined in the interference determination step and of adding a moving path of the first object model to the tree structure model as a branch in the interference determination step.

15. The information processing apparatus according to claim 14, wherein the control device moves the first object model from the starting point of the branch generated in trial in the virtual space based on the kinematics conditions in the first branch adding step.

16. The information processing apparatus according to claim 14, further comprising a second branch adding step in which the control device adds the branch generated in trial to the tree structure model in a case where no interference has determined in the interference determination step.

17. The information processing apparatus according to claim 16, wherein the control device repeatedly executes the trial step for generating the branch, the interference determination step, and the first branch adding step or the second branch adding step and in a case where the starting point is connected with the ending point through the tree structure model, executes a path generating step in which the control device generates a branch connecting from the starting point to the ending point on the tree structure model as a path along which the first object model is to be moved.

18. The information processing apparatus according to claim 14, wherein the branch generated by the control device in trial in the trial step is a branch connecting a first point generated in the virtual space with a second point closest to the first point in the tree structure model.

19. The information processing apparatus according to claim 14, wherein the control device determines that the interference has occurred in a case where a branch connecting a first point generated in the virtual space with a second point closest to the first point in the tree structure model interferes with the second object model.

20. The information processing apparatus according to claim 18, wherein the first point is generated on a line connecting a point generated at a random position in the virtual space with the second point.

21. The information processing apparatus according to claim 16, wherein the kinematics conditions include a condition of velocity or force in a case where the first object model comes into contact with the second object model in the first branch adding step, and
wherein the control device moves the first object model from a starting point of the branch generated in trial by using the velocity or force and adds the moving path in the tree structure model as a branch in the first branch adding step.

22. The information processing apparatus according to claim 18, wherein the control device uses the position of the starting point or the ending point of the motion of the first object model as a position of the first point to be generated at an arbitral position in the virtual space in the trial step repeatedly executed.

23. The information processing apparatus according to claim 14, further comprising a user interface unit configured to output a process of a change of the tree structure model in each step.

24. The information processing apparatus according to claim 14, further comprising a user interface unit configured to receive user operations of setting the starting point and the ending point of the motion of the first object model.
